(19) United States
(12) Patent Application Publication
(10) Pub. No.: US 2007/0249376 A1
(43) Pub. Date: Oct. 25, 2007

(54) INFORMATION PROCESSING DEVICE, INFORMATION PROCESSING METHOD, CONTROL PROGRAM FOR REALIZING INFORMATION PROCESSING METHOD BY COMPUTER, AND COMPUTER READABLE RECORDING MEDIUM WITH CONTROL PROGRAM RECORDED THEREON

(75) Inventors: Keigo Ogura, Nerima-ku (JP); Yasuo Komada, Inagi-shi (JP); Akiko Tokumaru, Kawasaki-shi, (JP); Kouichi Unno, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/736,611

(22) Filed: Apr. 18, 2007

(30) Foreign Application Priority Data
Apr. 19, 2006 (JP) 2006-115719
Dec. 6, 2006 (JP) 2006-329623

(51) Int. Cl. H04Q 7/20

(52) U.S. Cl. 455/466

(57) ABSTRACT

Sending of an electronic mail while associating an information processing device with a mobile information terminal conventionally imposes a troublesome operation on a user. An information processing device (100, 102) of the present invention can communicate with a mobile information terminal (1004) and includes a terminal detection unit (205, 512) for detecting the mobile information terminal 1004 in Step 3000 of FIG. 5, an obtaining unit (206, 511) for obtaining mail information in Step 4000 of FIG. 5 from the mobile information terminal 1004 in accordance with the detection of the mobile information terminal 1004 by the terminal detection unit (205, 512), and a sending unit (206, 511) for sending the electronic mail on the basis of the thus obtained mail information in Step 4000 of FIG. 5.

### BACKGROUND OF THE INVENTION

1. Field of the Invention

The present invention relates to an information processing performed by a mobile information terminal or an information processing device, such as a personal computer (hereinafter referred to as “PC”) or a multifunction peripheral (hereinafter referred to as “MFP”), which is connected on a network and provided with a sending and receiving function of an electronic mail.

2. Description of the Related Art

In recent years, the number of devices that can be connected on a network has increased. In such a situation, a mobile information terminal capable of performing wireless communication and an information processing device such as a PC or an MFP are being able to send and receive various data on the network between the terminal and the device. As such, there is a need to utilize the functions of the mobile information terminal and the functions of the information processing device in combination.

Information processing devices such as MFPS, typically provide a plurality of functions such as copying, printing, scanning, etc. In such devices, there is a general operation flow in which when data held in a memory or the like in the device is sent while being attached to an electronic mail, information such as electronic mail address that becomes a destination is input and settings for sending the mail are prepared.

As a conventional technique, Japanese Patent Laid-Open No. 2005-217648 discloses a technology for sending data from a mobile information terminal. More specifically, a mobile information terminal is connected to a multifunction device, and document data to be sent from the mobile information terminal are transferred to the multifunction device. The multifunction device then proceeds to send the data on behalf of the mobile information terminal.

However, with the conventional technology disclosed in Japanese Patent Laid-Open No. 2005-217648, in order to coordinate between the mobile information terminal and the multifunction device, it is necessary to set information for designating the sending type on the mobile information terminal. In addition, it is also necessary to issue an instruction for transferring the document data to be sent from the mobile information terminal to the multifunction device. Coordinating between the mobile information device and the multifunction device can be burdensome on the user.

### SUMMARY OF THE INVENTION

The present invention provides an information processing device in which, when an electronic mail function is used while coordinating between an information processing device such as a PC or an MFP and a mobile information terminal, it is possible to easily coordinate the devices and the terminal.

According to an aspect of the present invention, an information processing device capable of communicating with a mobile information terminal that is provided with an electronic mail composition function and a sending function, includes terminal detection unit for detecting the mobile information terminal, obtaining unit for obtaining mail information from the mobile information terminal in accordance with the detection of the mobile information terminal by the terminal detection unit, and sending unit for sending an electronic mail on the basis of the mail information obtained by the obtaining unit.

Further features of the present invention will become apparent from the following description of exemplary embodiments with reference to the attached drawings.

### BRIEF DESCRIPTION OF THE DRAWINGS

FIG. 1 illustrates a network configuration according to an embodiment of the present invention.

FIG. 2 is a block diagram illustrating a hardware configuration of a mobile information terminal used in an embodiment of the present invention.

FIG. 3 illustrates a process flow in detail for a mail composition on the mobile information terminal according to an embodiment of the present invention.

FIG. 4 illustrates a mail composition example of the mobile information terminal.

FIG. 5 illustrates a basic flow for a process in an embodiment of the present invention.

FIG. 6 is a block diagram illustrating a hardware configuration of a PC used in an embodiment of the present invention.

FIG. 7 illustrates a terminal detecting flow according to an embodiment of the present invention.

FIG. 8 illustrates a mail information obtaining flow according to an embodiment of the present invention.

FIG. 9 illustrates a mail information editing flow according to an embodiment of the present invention.

FIG. 10 illustrates a mail sending flow according to an embodiment of the present invention.

FIG. 11 illustrates a display example of a mail composition screen of the PC according to an embodiment of the present invention.

FIG. 12 illustrates a selection screen display example of the PC at a time when an attachment file is added according to an embodiment of the present invention.

FIG. 13 illustrates a display example after the editing on the mail composition screen of the PC illustrated in FIG. 11.

FIG. 14 a screen display example of the PC at a time when a sending device is selected according to an embodiment of the present invention.

FIG. 15 illustrates a mail information obtaining flow in detail illustrated in FIG. 5 according to an embodiment of the present invention.

FIG. 16 is a schematic diagram at a time when a device sensor is connected to an MFP used in an embodiment of the present invention.

FIG. 17 is a block diagram illustrating a hardware configuration of an MFP including the device sensor illustrated in FIG. 16.

FIG. 18 illustrates an example of an operation unit of the MFP illustrated in FIG. 16.

FIG. 19 illustrates a mail information editing flow according to an embodiment of the present invention.

FIG. 20 illustrates a mail sending flow according to an embodiment of the present invention.

FIG. 21 illustrates a screen display example during mail information obtaining of the MFP according to an embodiment of the present invention.

FIG. 22 illustrates a display example of a mail composition screen of the MFP according to an embodiment of the present invention.

FIG. 23 illustrates a display example of a sending menu screen of the MFP according to an embodiment of the present invention.

FIG. 24 illustrates a display example after the editing on the mail composition screen of the MFP illustrated in FIG. 22.

FIG. 25 illustrates a screen display example of the MFP at a time when a sending device selection is performed according to an embodiment of the present invention.

FIG. 26 is a schematic diagram illustrating a wireless communication connection performed among an MFP, a mobile information terminal, and a non-contact ID card according to an embodiment of the present invention.

FIG. 27 is a block diagram illustrating a hardware configuration of the non-contact ID card according to an embodiment of the present invention.

FIG. 28 illustrates a terminal detecting flow according to an embodiment of the present invention.

FIG. 29 illustrates an example of a display screen in a normal status in the PC.

FIG. 30 illustrates a copy standby screen in the MFP.

### DESCRIPTION OF THE EMBODIMENTS

Hereinafter, exemplary embodiments of the present invention will be described in detail with reference to the drawings.

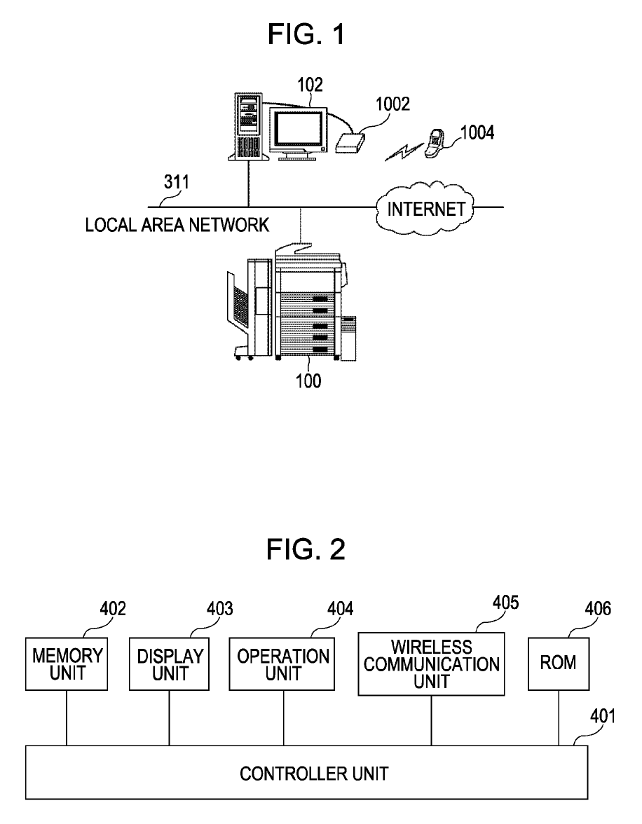

FIG. 1 illustrates a network configuration according to an embodiment of the present invention. As illustrated in FIG. 1, information processing devices (MFP 100, PC 102) are connected to a local area network (LAN) 311, where the LAN 311 is connected to a public Internet network. Furthermore, a device sensor 1002 is connected to the PC 102. The device sensor 1002 is a device for detecting a nearby mobile information terminal 1004 and is capable of performing wireless communication. The mobile information terminal 1004 includes a wireless communication function such as an electronic mail or Bluetooth.

The present invention is not limited to the network configuration illustrated in FIG. 1, and any configuration that would enable practice of the present invention is applicable. For example, the mobile information terminal can be any type of mobile device, such as a personal data assistant (PDA), notebook computer, etc. In addition, sending and receiving data can be accomplished via wireless or wired interfaces. Hereinafter, unless otherwise noted, for example/description purposes the PC 102 will be used as the information processing device.

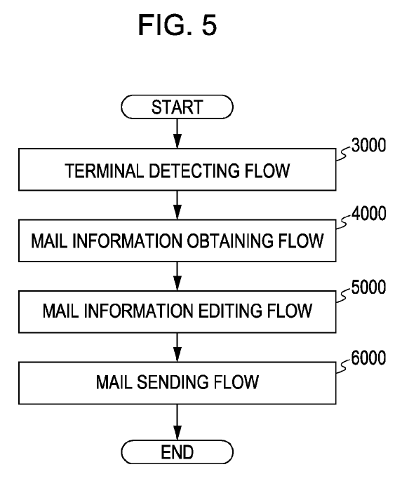

FIG. 5 illustrates an overall processing flow of the present embodiment. More specifically, according to the present embodiment, the process includes a terminal detecting flow 3000, a mail information obtaining flow 4000, a mail information editing flow 5000, and a mail sending flow 6000.

The terminal detecting flow 3000 is a process flow for detecting the mobile information terminal 1004 with which the PC 102 communicates. The mail information obtaining flow 4000 is a process flow in which the PC 102 obtains the mail information from the mobile information terminal 1004 in accordance with detection of the mobile information terminal 1004. The mail information editing flow 5000 is a process flow for editing the obtained mail information in the PC 102. The mail sending flow 6000 is a process flow for sending electronic mail. According to the present embodiment, the mail information editing flow 5000 need only be performed once. However, in order for a user to repeatedly edit mail information, the mail editing information flow 5000 can be performed multiple times until the user issues an electronic mail sending instruction.

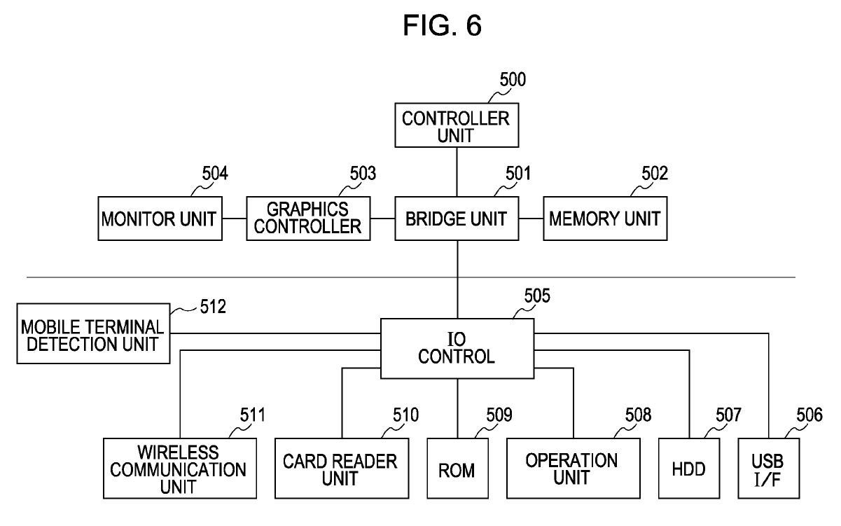

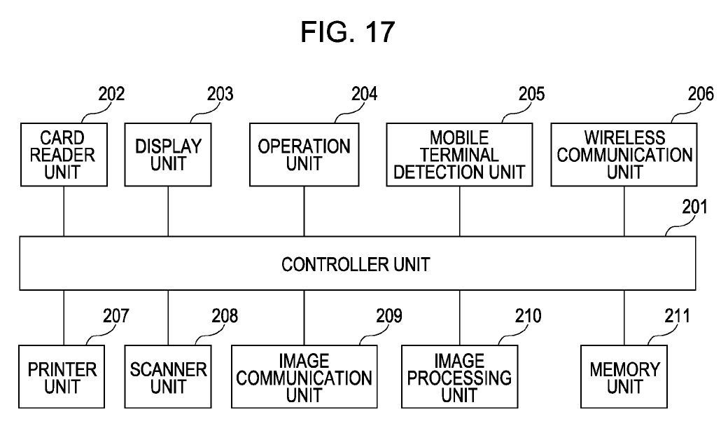

In the present embodiment, a control program for executing the flow illustrated in FIG. 5 is stored in a memory unit 502 or a ROM 509 (see FIG. 6), and in a memory unit 211 (see FIG. 17) as program code that can be executed by a controller unit of the PC 102.

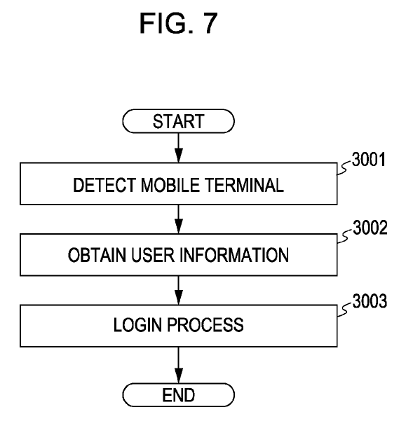

FIG. 7 illustrates the terminal detecting flow 3000. More specifically, in step 3001, the mobile information terminal 1004 is detected by the device sensor 102. In the present embodiment, detection occurs when the mobile information terminal 1004 is placed on the device sensor 102. However, any method for placing the mobile information terminal 1004 in a position to be detected by the device sensor 102 that would enable practice of the present invention is applicable.

Next, in step 3002, the PC 102 wirelessly communicates with the mobile information terminal 1004 to obtain user information. Then, in step 3003, a login process, using the user information, to log the user onto the PC 102 occurs.

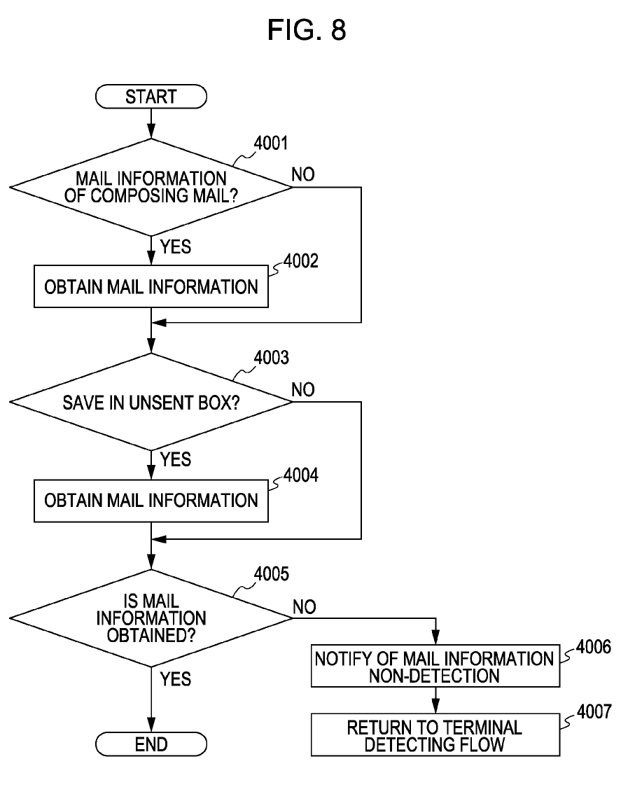

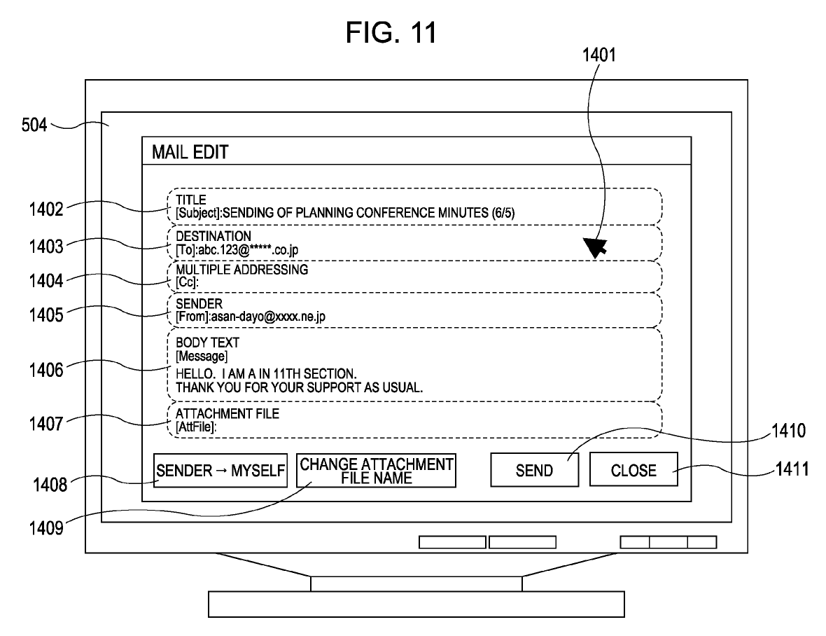

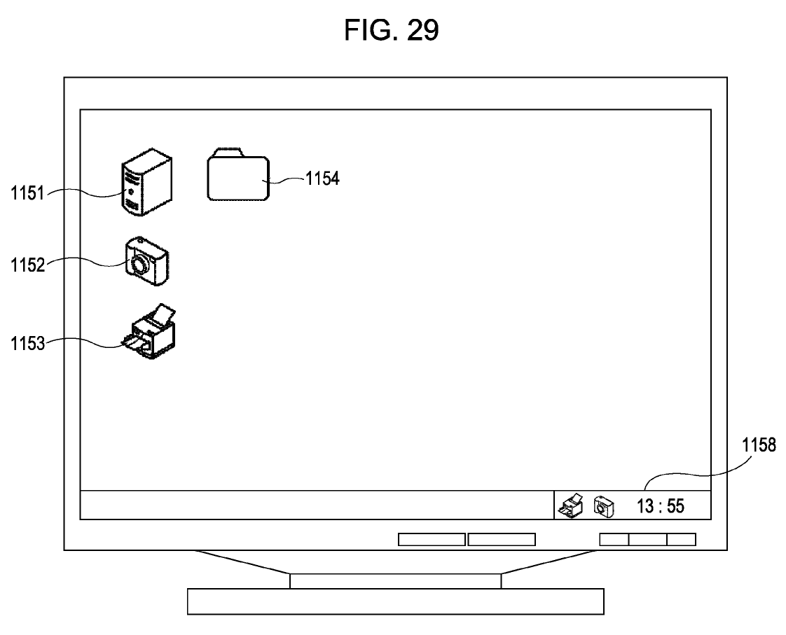

FIG. 8 illustrates the mail information flow 4000. This flow is a process flow of the PC 102 for obtaining the mail information from the mobile information terminal 1004 after detecting the mobile information terminal 1004 and performing the login process in the terminal detecting flow 3000. According to the present embodiment, in accordance with detection of the mobile information terminal 1004, the PC 102 transitions from a normal status (illustrated in FIG. 29) to an activation status of a mail composition application (illustrated in FIGS. 11 to 14). While the status before the transition is set as the normal status, the PC 102 may be in any status would allow activation of the mail composition application upon detection of the mobile information terminal 1004.

In addition, according to the present embodiment, when the mobile information terminal 1004 is detected, and mail information is present in the mobile information terminal 1004 that is to be obtained, the status of the PC 102 is transitioned to the activation status of the mail composition application. If no mail information is to be obtained, the mail composition application is not activated and screen notifying a user of this is displayed on the mobile information terminal 1004.

First, the PC 102 issues a transfer request to the mobile information terminal 1004 for the mail information when the mail composition screen is displayed on the mobile information terminal 1004. In step 4001, a determination is made whether mail information displayed on the mail composition screen is to be obtained from the mobile information terminal 1004.

If it is determined that the mail information displayed on the mail composition screen is to be obtained, then in step 4002, the PC 102 obtains the displayed mail information from the mobile information terminal 1004. In the present embodiment, the wireless communication unit 511 obtains the mail information. If it is determined that the mail information is not be obtained, flow proceeds to step 4003. In step 4003, a determination is made, based on a transfer request by the PC 102 for mail information being saved in a location in the ROM 406 of the mobile information terminal 1004, whether there is mail information being saved.

If it is determined that mail information is being saved, flow proceeds to step 4004, where the mail information is obtained from the mobile information terminal 1004. If it is determined that mail information is not being saved, flow proceeds to step 4005. The obtained mail information is stored in the memory unit 502 of the PC 102.

In step 4005, the PC 102 determines whether mail information has been obtained. If mail information has been obtained, flow proceeds to the mail information editing flow 5000 described below. If mail information has not been obtained, then in step 4006, the PC 102 notifies the user via the monitor unit 502 that no mail information was detected. Then, in step 4007, flow returns to the terminal detecting flow 4000.

In the mail information obtaining flow 4000 of the present embodiment, the PC 102 automatically obtains the mail information. However, in some cases there is a plurality of mail information saved in a location in the ROM 406. As such, according to the present embodiment, a user can select which particular mail information should be transferred from the mobile information terminal 1004 to the PC 102. In addition, according to the present embodiment, after the mail information is obtained, any unnecessary mail information remaining in the PC 102 is deleted.

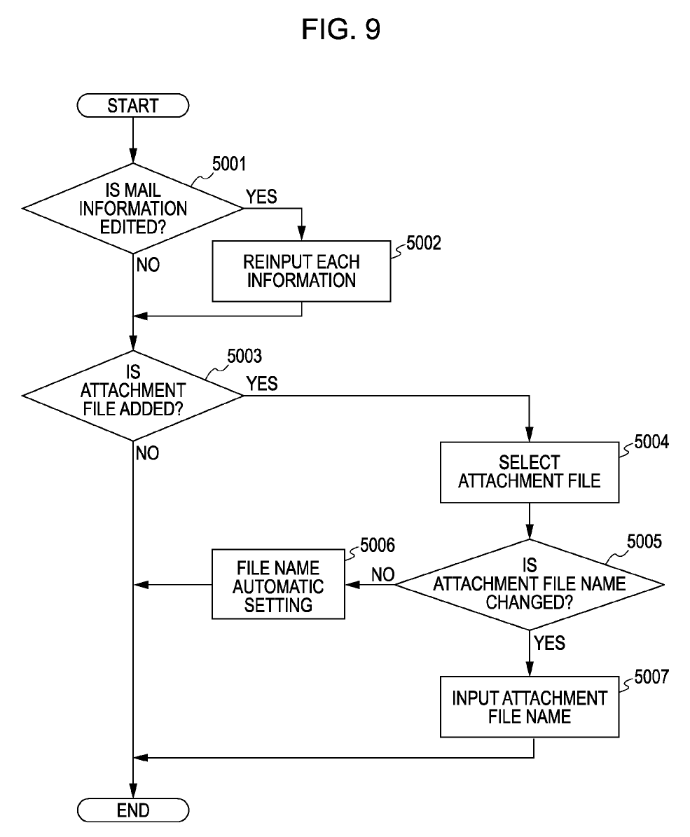

FIG. 9 illustrates the mail information editing flow 5000. In step 5001, a determination is made whether the mail information obtained in the mail information obtaining flow 4000 is to be edited. If the mail information is to be edited, flow proceeds to step 5002, where editing of the mail information occurs.

FIG. 11 illustrates a mail edit screen displayed on the monitor unit 502 used to edit the mail information. The mail edit screen includes, but is not limited to, the following fields: “Title” 1402, “Destination” 1403, “Multiple addressing” 1404, “Sender” 1405, “Body text” 1406, and “Attachment file” 1407. Mouse cursor 1401 is used to select the field to be edited.

FIG. 11 also includes “Send” button 1410, which is used to send the mail information in the form of an electronic mail, and “Close” button 1411, which is used to close the mail edit screen. “Sender” field 1405 contains the mail address of the PC 102. In order to change the sender of the mail information, “Sender→Myself” button 1408 is selected. For example, the mail address can be changed from the mail address of the PC 102 to the mail address of the mobile information terminal 1004.

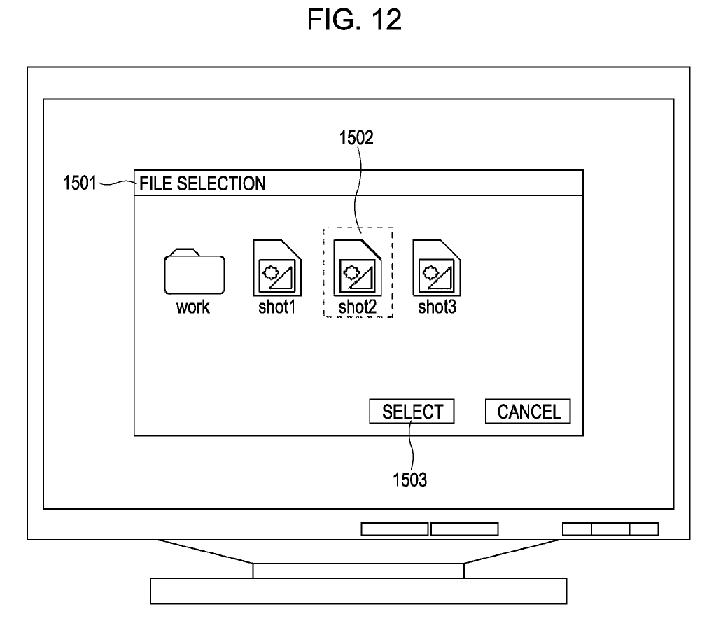

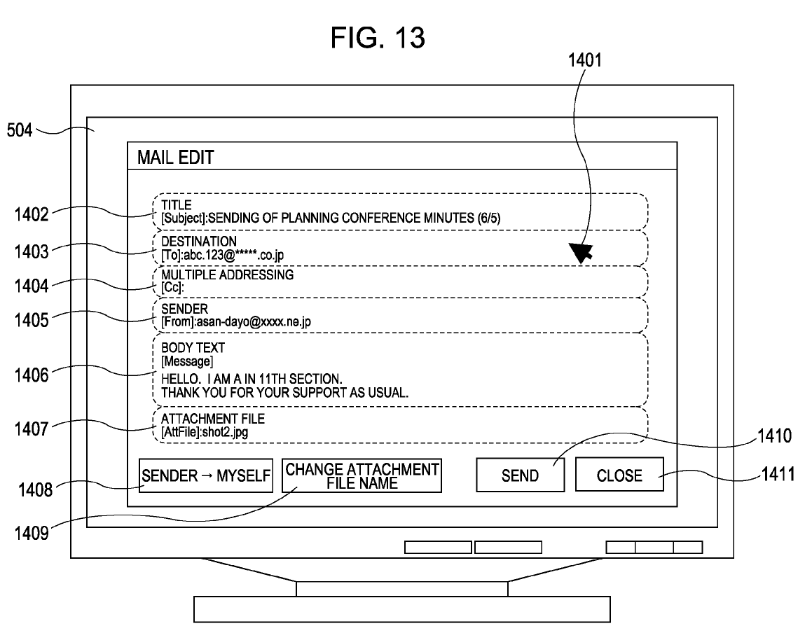

Returning to FIG. 9, in step 5003, a determination is made whether an attachment file has been added to the mail information. An attachment file is added by selecting the “Attachment file” field 1407. When the “Attachment file” field 1407 is selected, a file selection screen 1501 illustrated in FIG. 12 is displayed on the monitor unit 502. The file selection screen 1501 includes, but is not limited to, thumbnail images, such as “shot2” 1502. In order to attach a file, a file is selected using mouse cursor 1401 and then Select button 1503 is selected. Upon selection of a file to attach, the mail composition screen illustrated in FIG. 13 is displayed on the monitor unit 502.

Returning to FIG. 9, after a file for attachment is selected in step 5004, flow proceeds to step 5005, where a determination is made whether the name of the file is to be changed. If the file name is not to be changed, then in step 5006, the default file name assigned to the file is used. If the file name is to be changed, then in step 5007, the “Attachment file name change” button 1409 is selected and the file name is changed.

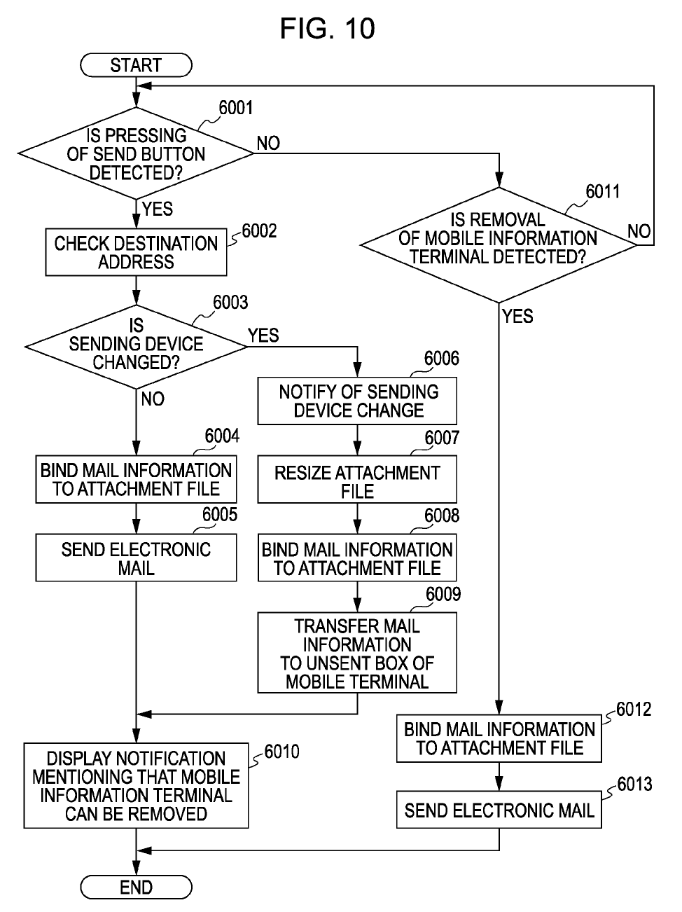

FIG. 10 illustrates the mail sending flow 6000. First, in step 6001, a determination is made whether the “Send” button 1401 has been selected. If the “Send” button 1401 has been selected, then in step 6002, the PC 102 checks the destination address. Next in step 6003, a determination is made whether the sending device is to been changed based on the destination address.

If, in step 6003, no change in the sending device occurs, then in step 6004, the mail information and the attachment file are bound together. In the present embodiment, binding the mail information and the attachment file consists of binding the data saved in the memory unit 502 to the mail information based on the attachment file information selected in the mail information editing flow 5000. In addition, according to the present embodiment, the data is bound when the electronic mail is sent. However, the data can be bound to the mail information at the time it is selected in the mail information editing flow 5000. In step 6005, the electronic mail is sent from the PC 102. Then, in step 6010, the PC 102 notifies the user via monitor unit 504 that the mobile information terminal 1004 can be removed.

Returning to step 6003, if the sending device is changed, flow proceeds to step 6006, where notification is provided that the sending device has changed, i.e., sending is being performed from the mobile information terminal 1004 instead of the PC 1002. The sending device can be changed, for example, in a situation where the receipt of electronic mail from PC 102 might be rejected due to reception settings at the location/destination where the electronic mail is to be sent.

Next, in step 6007, the PC 102 resizes, e.g., compresses, the data size of the attachment file so that the size of the file is reduced to a level at which the data can be browsed on the mobile information terminal 1004. In step 6008, the mail information and the attachment file are bound together. Then, in step 6009, the mail information is wirelessly transferred to mobile information terminal 1004 and stored in the location in the ROM 406 where unsent messages are stored. A user can then send the mail information as electronic mail from the mobile information terminal 1004. Flow then proceeds to step 6010, which is described above.

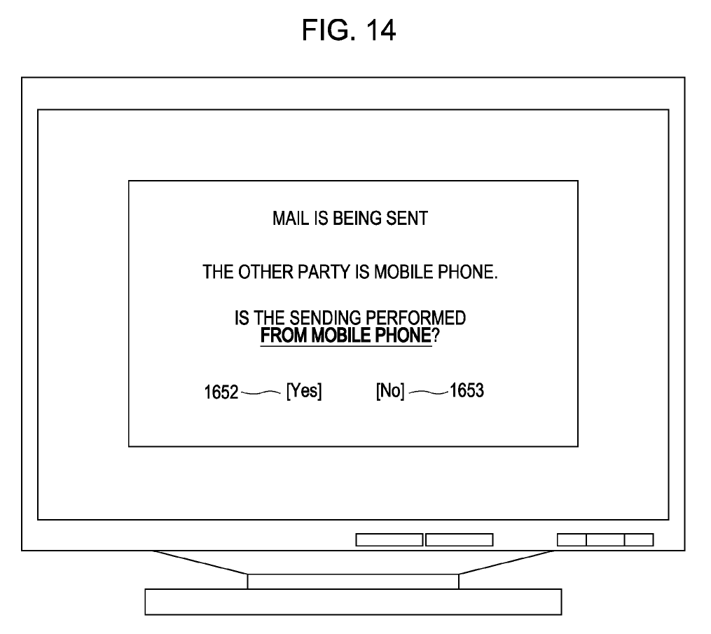

When the mail information is transferred in step 6009, according to the present embodiment, a sending device checking screen as illustrated in FIG. 14 is displayed. If a user determines that the sending device does not need to be changed, then “No” button 1653 is selected. As a result, transfer of the mail information is interrupted and the mail is eventually sent from the PC 102. If a user determines that the sending device is to be changed, then “Yes” button 1652 is selected.

Returning to step 6001, if detection of the “Send” button 1410 is not detected, then flow proceeds to step 6011, where the PC 102 detects whether the mobile information terminal 1004 has been removed from the device sensor 1002. If removal of the mobile information terminal 1004 is detected, then in step 6012, the PC 102 automatically binds the mail information and the attachment file together. In step 6013, the electronic mail is automatically sent.

In addition to the above described processing, according to the present embodiment, when a failure occurs in sending the electronic mail, the mobile information terminal 1004 is notified of the failure.

Next, a description will be provided of the mobile information terminal 1004 according to the present embodiment. FIG. 2 is a block diagram illustrating a hardware configuration of the mobile information terminal 1004. A controller unit 401 executes a control program stored in a ROM 406 to control the operation of the entire of mobile information terminal 1004. A wireless communication unit 405 performs data communication with an external device through the use of a wireless communication means such as Bluetooth. In the case where communication occurs in a wired environment, the mobile information terminal 1004 would include an interface, such as USB, to facilitate the wired communication.

A display unit 403 displays image data stored in, for example, a memory unit 402 and has display means such as liquid crystal (LCD). Also, the memory unit 402 is provided with an area for temporally saving mail information related to an unsent electronic mail.

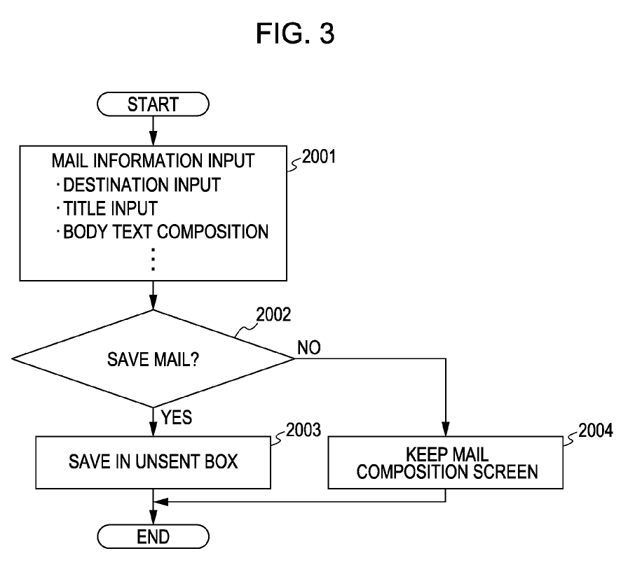

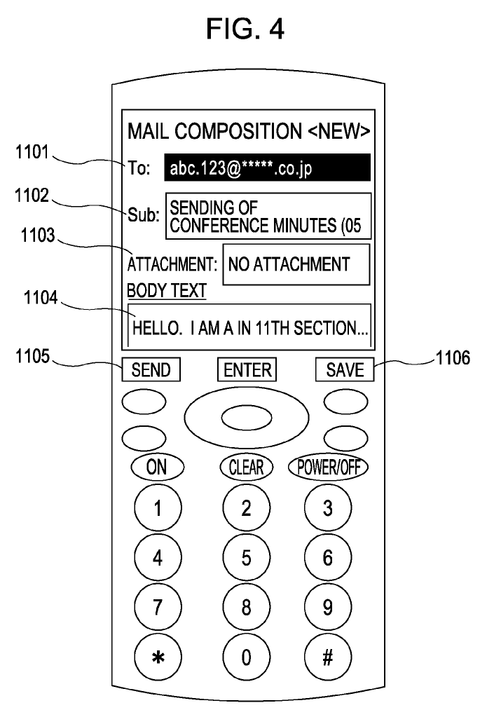

FIG. 3 illustrates a processing flow for composing an electronic mail by a user on the mobile information terminal 1004. First, in step 2001, a user activates a mail composition screen of the mobile information terminal 1004, and composes an electronic mail message via the mail composition screen. FIG. 4 illustrates an example of the mail composition screen according to the present embodiment.

As illustrated in FIG. 4, the user can input mail information such as destination input, title input, and body text composition. The destination mail address is input in a “To” field 1101, the title is input in a “Sub” field 1102, an attachment file is set in a “Attachment” field 1103, and a sentence to be sent is input in a “Body text” field 1104.

According to the present embodiment, the mail information that the user wishes to send from the mobile information terminal 1004 via the information processing device is unsent mail information. More specifically, before the mail information is sent by selecting the send button 1105, the mail information is either still being displayed on the mail composition screen or has been saved in a location in the ROM 406 where unsent messages are stored.

Returning to FIG. 3, in step 2002, a determination is made whether the mail information is to be saved. If the user presses a save button 1106 then in step 20003, the mail information in saved in a location in the ROM 406 known as the “unsent BOX”. If it is determined that the mail information is not to be saved, i.e., the save button 1106 is not pressed, the mail composition screen continues to be displayed. The mail composition screen also continues to be displayed if the send button 1105 is not pressed.

FIG. 6 is a block diagram illustrating a hardware configuration of the PC 102 including the device sensor 1002 in FIG. 1. A memory unit (system memory) 502 and a graphics controller 503 are connected to a controller unit 500 via a bridge unit 501. A monitor unit (monitor device) 504 is connected to the graphic controller 503. The bridge unit 501 is for example a bus such as a PCI (Peripheral Component Interconnect).

The bridge unit 501 is connected to an IO Control block (input and output interface control block) 505. A USB I/F (USB interface) 506, an HDD (hard disk drive) 507, an operation unit 508 such as a key board or a mouse, and a ROM 509 are connected to the IO Control block 505. In addition, a card reader unit 510, a wireless communication unit 511, and a mobile terminal detection unit 512 for detecting the presence or absence of the mobile information terminal 1004 in the vicinity of the device sensor are also connected to the IO Control block 505. According to the present embodiment, the device sensor 1002 includes, but is not limited to, the mobile terminal detection unit 512, the card reader unit 510, and the wireless communication unit 511.

The mobile terminal detection unit 512 is adapted to detect an electric wave emitted from the mobile information terminal 1004 as a user holds the mobile information terminal 1004 over the device sensor 1002 to thereby detect the presence or absence of the mobile information terminal 1004. However, the configuration of the present embodiment is not limited to this method, and any method in which the device sensor 1002 is able to detect the presence or absence of the mobile information terminal 1004, such as the device sensor 1002 detecting the weight of the mobile information terminal 1004 when the mobile information terminal 1004 is placed on the device sensor 1002, that would enable practice of the present invention is applicable.

The wireless communication is conducted in such a manner that the card reader unit 510 generates an electric wave for conducting the wireless communication at all times or an electric wave from the outside is utilized. In the card reader unit 510, after the detection of the mobile information terminal 1004, a wireless communication is established with the mobile information terminal 1004, thereby activating an application software by the PC 102.

The wireless communication unit 511 performs data communication with the mobile information terminal 1004 via wireless communication methods such as Bluetooth or a wireless LAN. Also, according to the present embodiment, the PC 102 uses the wireless communication unit 511 to send and receive electronic mail through the LAN 311 or the public Internet network. For example, when the mobile information terminal 1004 is detected, the card reader 510 begins communicating with the mobile information terminal 1004, and the mail information is transferred to the mobile information terminal 1004 via the wireless communication unit 511. While the present embodiment describes using wireless communication to send electronic mail, sending electronic mail via a wired connection is also applicable to the present embodiment.

As previously indicated, the PC 102 was used as the information processing device for example/description purposes. According to the present embodiment, any information processing device, such MFP 100, which would enable practice of the present invention is applicable.

FIG. 29 illustrates an example of a display screen in a normal status of the PC 102. On the display, it is possible to create an icon as a graphical interface 1151 for accessing data in a personal computer or to create an icon for devices connected to the PC 102, such as a camera 1152 or a printer 1153. Also, data created by a personal computer or other device is saved in a folder 1154. Furthermore, a current time and an activated application status are displayed as task trays 1158.

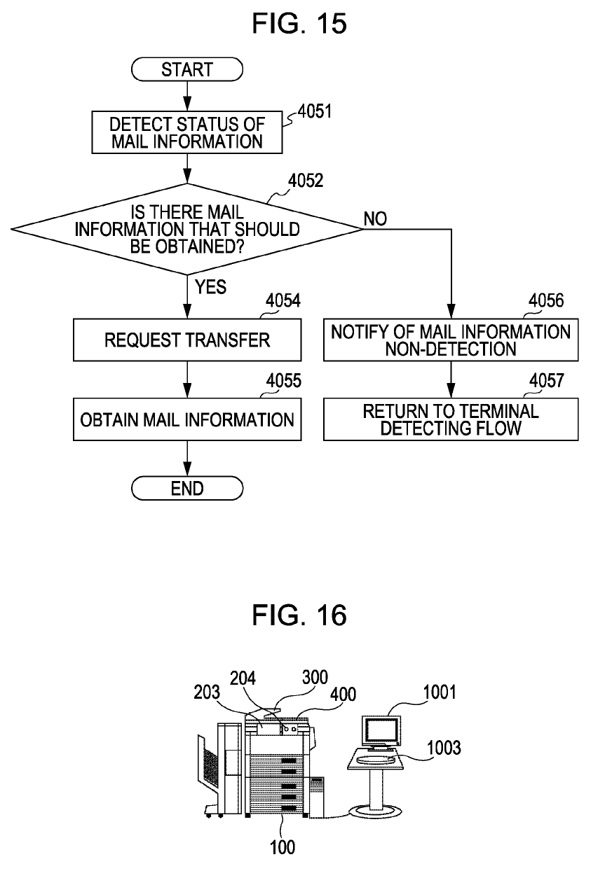

FIG. 15 illustrates another embodiment of the present invention. More specifically, FIG. 15 illustrates alternate processing of the mail information obtaining flow 4000. The flow in FIG. 15 is a process flow in which the mobile information terminal 1004 is detected in the terminal detecting flow 3000, the login process is performed, and thereafter the PC 102 obtains the mail information from the mobile information terminal 1004 in accordance with those processes. Also, according to this embodiment, the mail information is obtained by the wireless communication unit 511.

First, in step 4051, the PC 102 detects a status of the mail information held at the mobile information terminal 1004 via the wireless communication unit 511. In accordance with the detected status of the mail information, the PC 102 determines in step 4052 whether there is mail information that should be obtained.

If it is determined that there is mail information that should be obtained, flow proceeds to step 4054, where the PC 102 issues a transfer request to the mobile information terminal 1004 to provide mail information. More specifically, the mail information to be provided is either the mail information saved in a location in the ROM 406 of the mobile information terminal 1004 or the mail information displayed on the mail composition screen. Next, the PC 102 obtains the mail information transferred from the mobile information terminal 1004 in step 4055. The mail information obtained at this time is held at the memory unit 502.

If, there is no mail information that should be obtained, then flow proceeds to step 4056, where the PC 102 notifies the user via the monitor unit 504 that no mail information was detected. Next, in step 4057, process returns to the terminal detecting flow 3000.

It should be noted that in some instances, the mobile information terminal 1004 contains a plurality of unsent mail information being saved in the ROM 406 and being displayed on the mail composition screen. According to the present embodiment, in such a case, a transfer request with respect to the mail information displayed on the mail composition screen is given priority.

In addition, when a plurality of pieces of the mail information are being saved in the ROM 406, a user is able to select particular mail information to be transferred from the mobile information terminal 1004 to the PC 102. Moreover, after the mail information is obtained, any unnecessary mail information remaining in the PC 102 is deleted.

Another embodiment of the present invention will now be described with reference to FIGS. 16 to 25. In the present embodiment, MFP 100 is used as the information processing device for example/description purposes. The processes described above are also applicable to the present embodiment. While the present embodiment is described with respect to MFP 100, any information processing device that would enable practice of the present invention is applicable.

FIG. 16 illustrates a configuration of the present embodiment where a device sensor 1003 is connected to the MFP 100. A feeder 300 and a pressure plate 400 constitute a scanner unit for implementing a scanner function of the MFP 100. In addition to the scanner function, MFP 100 also includes a copy function, a printer function, and a facsimile function. The MFP 100 also includes display units 203 and 1001, and an operation unit 204.

FIG. 17 is a block diagram illustrating a hardware configuration of the MFP 100 including the device sensor 1003 in FIG. 16. The MFP 100 includes, but is not limited to, a controller unit 201, a card reader unit 202, a display unit 203, an operation unit 204, a mobile terminal detection unit 205, a wireless communication unit 206, a printer unit 207, a scanner unit 208, an image communication unit 209, an image processing unit 210, and a memory unit 211. The device sensor 1003 includes, but is not limited to, the mobile terminal detection unit 205, the card reader unit 202, and the wireless communication unit 206.

The mobile terminal detection unit 205 is adapted to detect an electric wave transmitted from the mobile information terminal 1004 while the user holds the mobile information terminal 1004 over the device sensor 1003 to thereby detect the presence or absence of the mobile information terminal 1004. Detection of the mobile information terminal 1004 is not limited to this method, and any method that would enable detection of the mobile information terminal 1004 is applicable. For example, placing the mobile information terminal 1004 on the device sensor 1003.

An electric wave is generated from the card reader unit 202 all the time for conducting wireless communication or an electric wave from the outside is used to establish wireless communication. In the card reader unit 202, after the mobile information terminal 1004 is detected, wireless communication with respect to the mobile information terminal 1004 is established, whereby the MFP 100 activates a software application.

The wireless communication unit 206 is a block for conducting data communication with a wireless communication device such as the mobile information terminal 1004 based on a wireless communication method such as Bluetooth or a wireless LAN. The wireless communication unit 206 is composed of an antenna unit, an RF (Radio Frequency) unit, and a base band unit. Also, according to the present embodiment, the MFP 100 conducts the sending and receiving of electronic mail via the LAN 311 or the public Internet network via the wireless communication unit 206. It should be noted that the sending and receiving of the electronic mail is not limited to a wireless connection and may also be realized by a wired connection.

For example, when the mobile terminal detection unit 205 detects the mobile information terminal 1004, the card reader unit 202 starts communicating with the mobile information terminal 1004, and the MFP 100 activates a driver software with which the mail information can be obtained. After that, the wireless communication unit 206 performs the transfer of the mail information.

The display unit 203 is adapted to issue an operation instruction with respect to the user and display a print preview of an image that should be printed. The display unit 203 is represented, for example, by a liquid crystal panel.

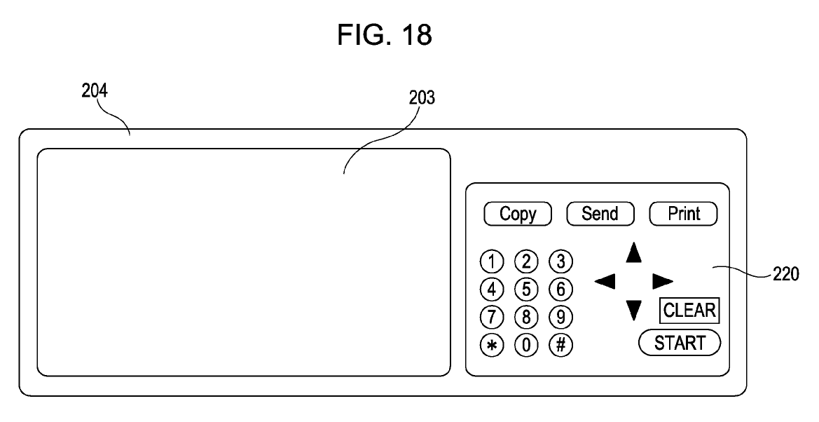

The operation unit 204 is adapted to select through a key operation the operation that the user desires to conduct. For example, the operation unit 204 is composed of a liquid crystal panel and provides a user interface with which the user operates the MFP 100. The display unit 203 and the operation unit 204 can be combined into a single unit, as illustrated in FIG. 18, or as individual units. As illustrated in FIG. 18, in addition to the display unit 203, the operation unit 204 also includes an input unit 220.

The printer unit 207 prints an electric image signal as a visible image on a recording sheet and is realized based on an electrophotography method or an inkjet method.

The scanner unit 208 optically reads an original image to be converted into an electric image signal and includes, but is not limited to, a contact image sensor, a read drive unit, a read lighting control unit, and the like. When the original image is scanned by the contact image sensor which is conveyed by the read drive unit, the read lighting control unit performs the lighting control of an LED inside the contact image sensor. At the same time, a photo sensor inside the contact image sensor optically reads the original image to be converted into an electric image signal.

The image communication unit 209 performs the sending and receiving of data with an external device. The image communication unit 209 is connected to the Internet network, a LAN, or a public telephone circuit to perform a facsimile communication.

The image processing unit 210 performs a read image process, a communication image process, and a recorded image process. In the read image process, the image data received from the scanner unit 208 is subjected to a shading correction, and then a gamma process, a binary process, a halftone process, or a color conversion process from RGB to CMYK is conducted for conversion into high-definition image data. In the recorded image process, the image data is converted in resolution in accordance with the recording resolution. Various image processes such as change in magnification of the image, smoothing, and color density correction are conducted for the conversion into the high-definition image data to be output to a laser beam printer. A communication image process unit is adapted to perform resolution conversion of the read image in accordance with a communication performance, color conversion, resolution conversion of the image received through the communication in accordance with a recording performance.

The memory unit 211 is a memory device such as a DDR-SDRAM or a hard disk. The memory unit 211 temporarily stores the image data as well as stores the control program, data, etc. that is used by the controller unit 201 to realize the function of the MFP 100.

The controller unit 201 includes a CPU and controls on the MFP 100. The controller unit 201 is electrically connected to each unit and performs the control for realizing any advanced functionality. For example, the controller unit 201 controls the scanner unit 208 to read original image data and controls the printer unit 207 to output the image data on a recording sheet. The controller unit 201 also provides a network scanner function of sending the image data read from the scanner unit 208 to another terminal on the network via the image communication unit 209. In addition, the controller unit 201 provides a printer function of converting code data that is received from the network via the image communication unit 209 into the image data and outputting the image data to the printer unit 207.

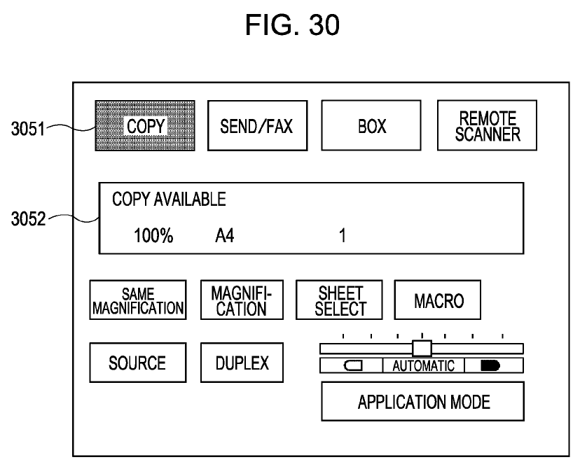

FIG. 30 illustrates a copy standby screen in the MFP 100. The screen represents that a copy tab 3051 is in an active status and once a copy button (not shown) on the MFP 100 is pressed, the copy starts on an A4 sheet with an enlargement factor of 100% as illustrated in a copy information field 3052. In addition, the copy standby screen also includes such items variable power, sheet selection, sorter, finishing, contrasting density, and application mode for a time when the image is to be copied. When the send/fax, box scan, or remote scanner function is used, each function tab is put in the active status and the detailed setting may be performed.

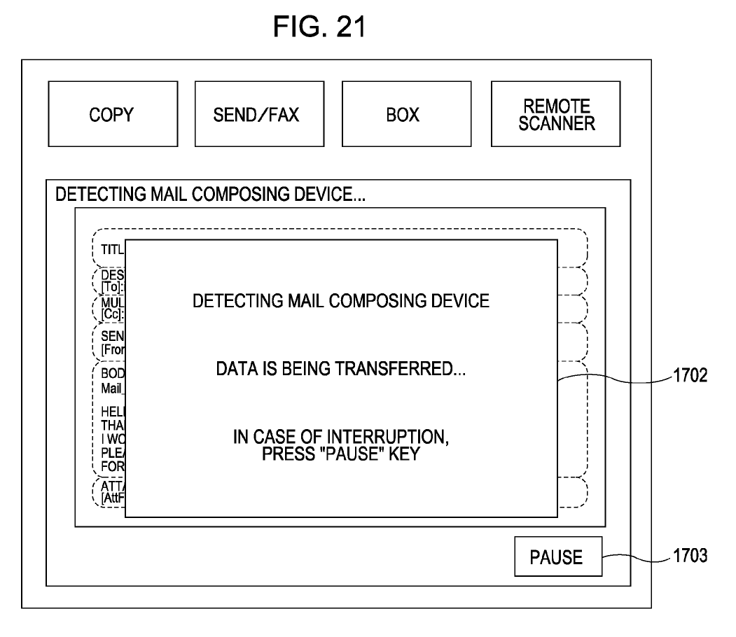

As described above, in accordance with the detection of the mobile information terminal 1004 in the terminal detecting flow 3000, the status illustrated in FIG. 30 is shifted to the status where the mail composition application is activated (FIGS. 21 to 25). Also, at this time, the status before the shift to the status where the mail composition application is activated may be in the copy standby status as described above or an activated status of other application that can be realized by the MFP 100. Furthermore, in a case where the mobile information terminal 1004 is detected, when the mobile information terminal 1004 includes mail information to be obtained, the status is shifted as described above. When there is no mail information to be obtained, a notice to this effect is displayed on the screen of the mobile information terminal 1004 or the mail composition application is not activated.

FIG. 21 illustrates the display 1702 associated with the MFP 100 obtaining the mail information from the mobile information terminal 1004 via the mail information obtaining flow 4000. “Pause” button 1703 is used to interrupt the transfer of the mail information.

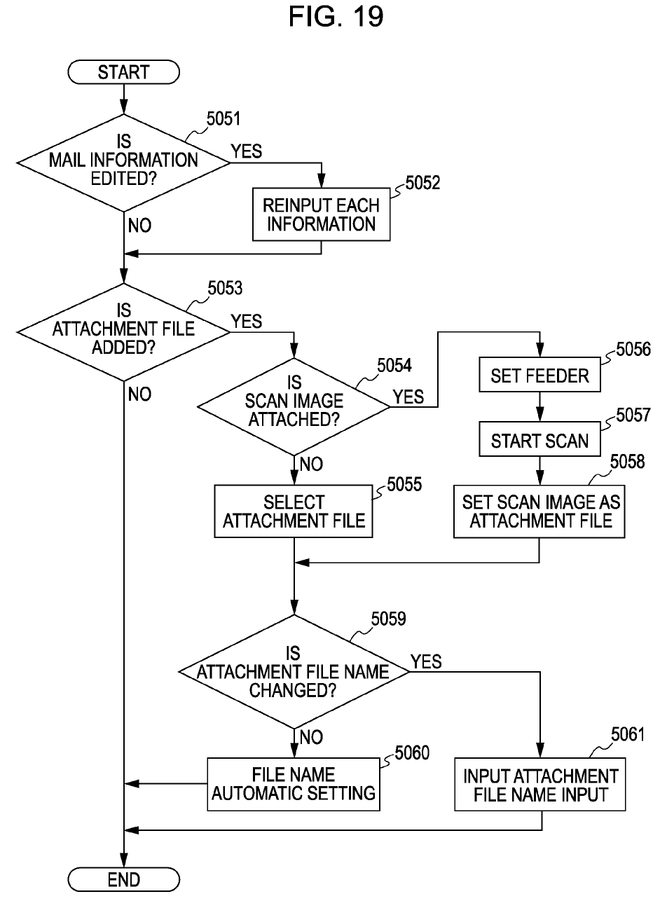

FIG. 19 illustrates the mail information editing flow (5000) according to the present embodiment.

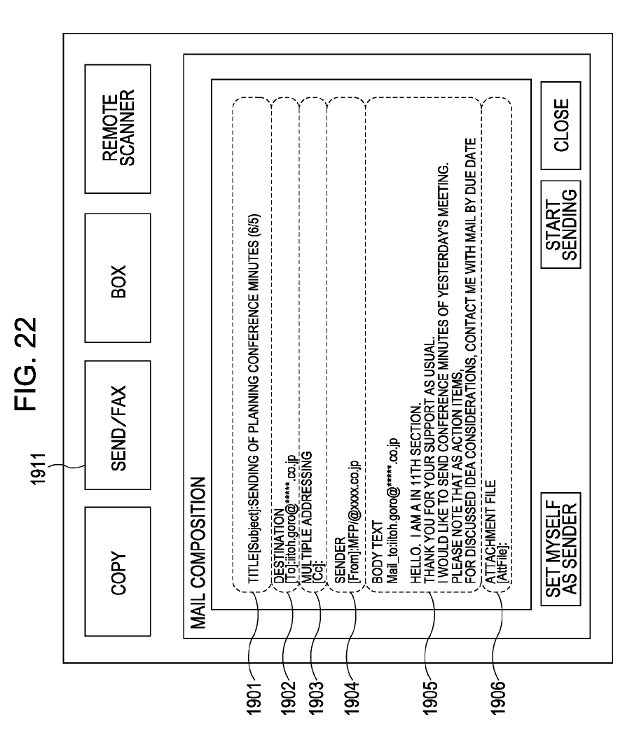

First, in step 5051, a determination is made whether an edit process is to be performed on the obtained mail information. If the mail information is to be changed, flow proceeds to step 5052, where the new information is inputted. The MFP 100 displays the mail composition screen illustrated in FIG. 22 on the display unit 203 based on the obtained mail information. In FIG. 22, the fields “Title” 1901, “Destination” 1902, “Multiple addressing” 1903, “Sender” 1904, “Body text” 1905, and “Attachment file” 1906, include the information set on the mobile information terminal 1004.

If it is determined that no mail information is to be edited or after any editing is completed, flow proceeds to step 5053, where the user determines whether an attachment file is to be added to the mail information. If an attachment file is to be added, then in step 5054, a determination is made whether the contents of the file to attach is obtained via the scanner unit 208.

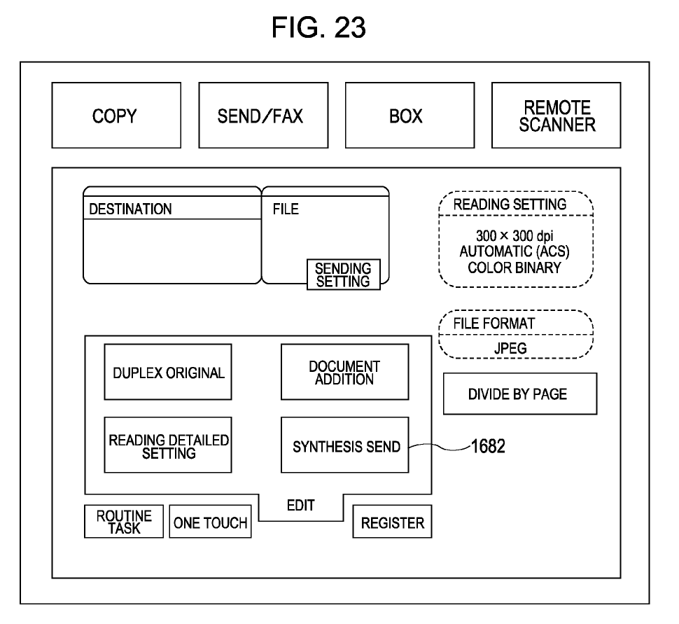

If the contents are obtained via the scanner unit 208, then in step 5056, the original image is placed either in the feeder 300 or on the pressure plate 400. Next, in step 5057, the original image is scanned. The scanning operation is initiated by first selecting the “Send/Fax” button 1911, which results in the send menu screen illustrated in FIG. 23 being displayed on the display unit 203. Then, the “Synthesis Send” button 1682 is selected, and the MFP 100 begins the scanning operation. In step 5058, the scanned image is set as the attachment file.

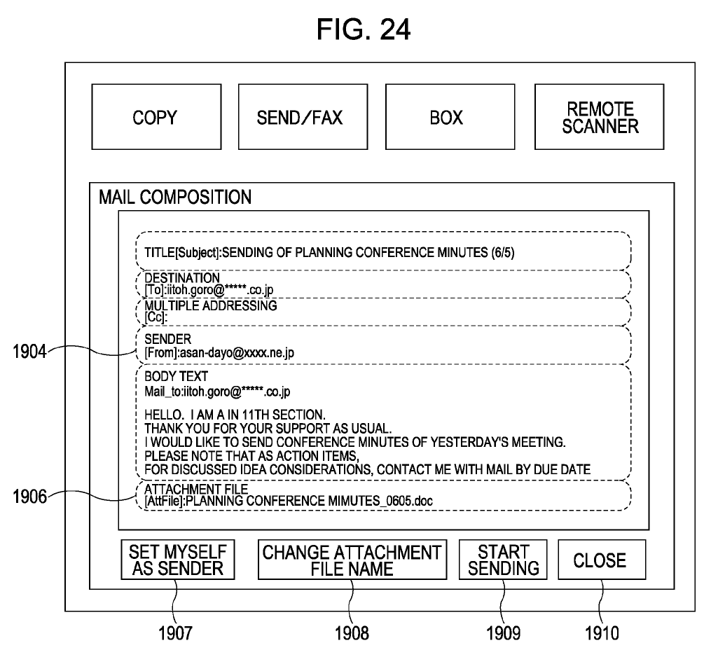

If the contents of the file to be attached are not obtained via the scanner unit 208, then flow proceeds to step 5055, where a user uses the “Attachment file” 1906 field to add the attachment file. As in the previously described embodiment, the file selection screen is selected while the file to be attached is held in the memory unit 211 of the MFP 100. When the selection of the attachment file is completed, the mail composition screen illustrated in FIG. 24 is displayed with the attached file added to the “Attachment file” field 1906.

In step 5059, a determination is made whether the attachment file name is to be changed. If the file name is to be changed, flow proceeds to step 5061, where “Attachment file name change” button 1908 is selected to change the file name. If the file name is not to be changed, then flow proceeds to step 5060, where the MFP 100 automatically sets the file name.

The “Sender” field 1904 on the mail composition screen illustrated in FIG. 22 denotes a mail address of the MFP 100. If a user wishes to change the information in this field, the user selects the “Sender→Myself” button 1907, as illustrated in FIG. 24 In addition, by selecting a “Close” button 1910, it is possible to forcedly terminate the mail composition screen.

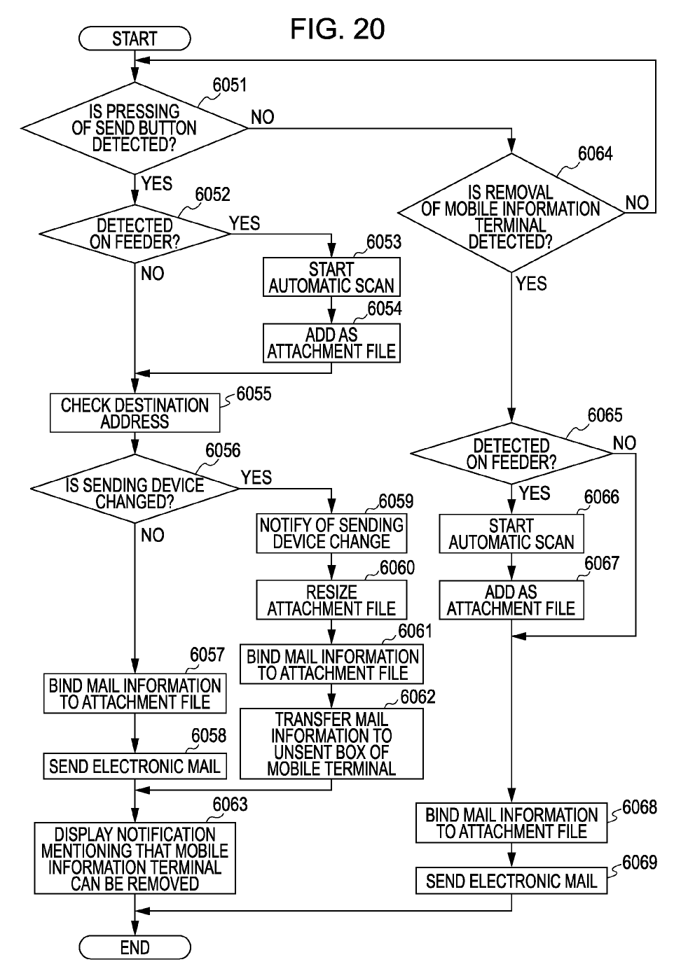

FIG. 20 illustrates the mail sending flow (6000) according to the present embodiment. First, in step 6051, it is detected whether the “Send” button 1909 is pressed. If the “Send” button is selected, then flow proceeds to step 6052, where the MFP 100 detects the presence or absence of an original on the feeder 300 or on the pressure plate 400. If the original is detected, then in step 6053, the MFP 100 automatically starts the scanning operation, and in step 6054, automatically sets a file name and adds the input image as an attachment file.

If no original is detected or after the input image had been added as an attachment, in step 6055, the MFP 100 checks the destination address of the mail information. In step 6056, a determination is made whether the sending device is to be changed based on the destination address. If the destination of the electronic mail designated by the destination mail address of the mail information is the PC 102, no change in the sending device is conducted. In step 6057, the mail information and the attachment file are bound together, and in step 6058, the electronic mail is sent from the MFP 100. In step 6063, the MFP 100 provides notification via the display unit 203 that mobile information terminal 1004 has been removed.

If the destination of the electronic mail designated by the destination mail address of the mail information is a mobile phone, then in step 6059, the user is notified that the sending is performed from the mobile information terminal 1004 as the sending device. This setting is made, for example, in a case where the receipt of an electronic mail from different devices such as a PC might be rejected due to reception settings for an electronic mail of the mobile phone at the destination party. In step 6060, the MFP 100 compresses (resizes) the data size of the attachment file so that the size is reduced to a level at which the mobile information terminal 1004 can browse the data.

Next, in step 6061, the mail information and the attachment file are bound together. In step 6062, the mail information is transferred to a location in the ROM 406 of the mobile information terminal 1004. Then in step 6063, the MFP 100 provides notification via the display unit 203 that the mobile information terminal 1004 has been removed.

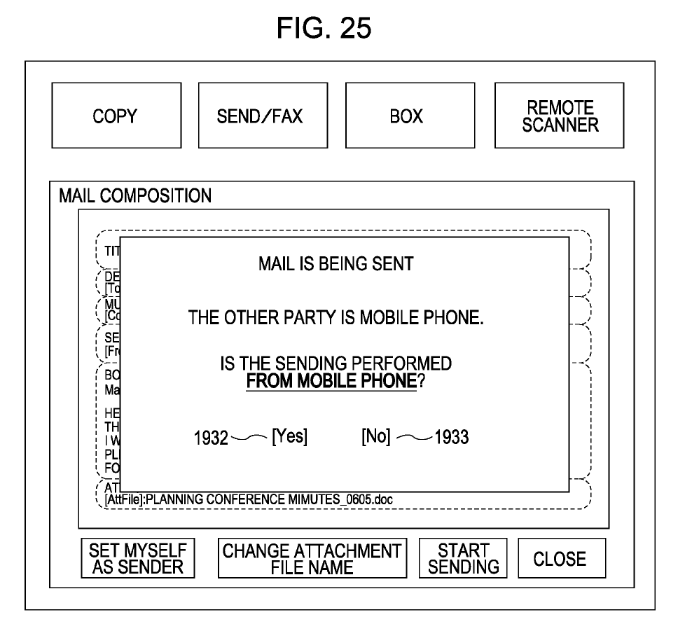

In other embodiment, a configuration is adopted such that the sending device check screen illustrate in FIG. 25 is displayed. When the user determines that the sending device does not need to be changed, the sending device check screen illustrated in FIG. 25 is displayed, and the “No” button is selected. Then, the transfer of the mail information is interrupted and it is possible to send the mail information from the MFP 102.

If, in step 6051, selection of the “Send” button 1909 is not detected, flow proceeds to step 6064, where the MFP 100 detects whether the mobile information terminal 1004 has been removed from the device sensor 1003. If removal of the mobile information terminal 1004 is detected, then in step 6065, the MFP 100 detects the presence or absence of an original on the feeder 300 or on the pressure plate 400. If an original is detected, then in step 6066, the MFP 100 automatically starts the scanning operation, and automatically set a file name and adds the input image as an attachment file in step 6067. Next, in step 6068, the mail information and the attachment file are bound together, and the sending of the electronic mail is performed in step 6069.

According to the present embodiment, the mobile information terminal 1004 can be notified if the scanning operation fails or the transmission of the electronic mail fails. In addition, according to the present embodiment, after the mobile information terminal 1004 is removed from the device sensor 1003, if sending of the electronic mail fails, the user is notified of the error via the display unit 203 of the MFP 100. In these two instances, after the error notification, the process returns to the mail information editing flow 5000.

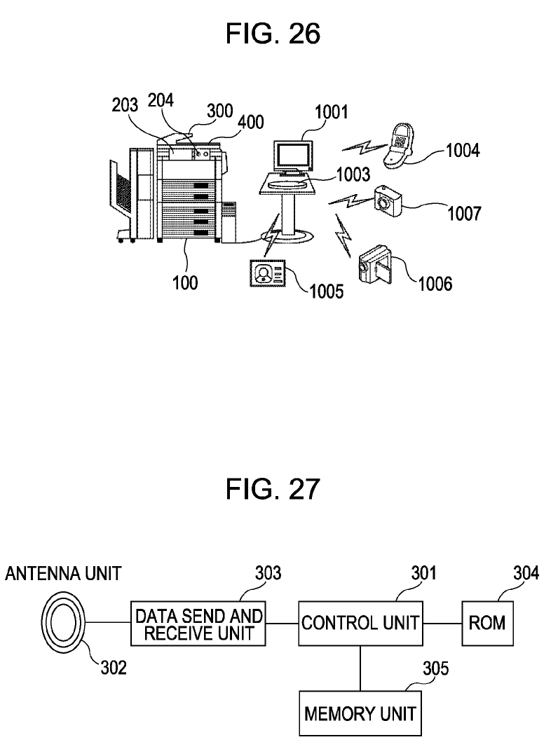

According to the terminal detecting flow 3000 of the present embodiment, the mobile information terminal 1004 is placed close to the device sensor 1003 in order for the device sensor 1003 to detect the mobile information terminal 1004. Also, according to the mail sending flow 6000 of the present embodiment, the mobile information terminal 1004 is removed from the device sensor 1003, thereby automatically sending the electronic mail. At that time, when an original is placed on a feeder, etc., an image is automatically read and added as an attachment file to the mail information. In other words, when the user performs a simple operation of placing the mobile information terminal 1004 close to the device sensor 1003) and then moving it away, the mail information can be transferred from the mobile information terminal 1004 to the MFP 100 and the electronic mail to which the input image is added from the MFP 100 Another embodiment of the present invention will be described with reference to FIGS. 26 to 28. As in the previous embodiment, the MFP 100 is represented as an example of the information processing device.

FIG. 26 illustrates a configuration of the present embodiment. Only those parts that are different from the previously discussed embodiments will be discussed here. More specifically, instead of a single mobile information terminal 1004, the present embodiment includes multiple information terminals, such as digital video camera 1006, and digital camera 1007. In addition, the present embodiment also includes non-contact ID card 1005. According to the present embodiment, a non-contact ID card 1005 is used by the mobile information terminals for performing wireless communication with the MFP 100.

FIG. 27 is a block diagram illustrating a hardware configuration of the non-contact ID card 1005. The non-contact ID card 1005 is adapted to receive electric waves from the outside and utilize an induced electric power obtained via a loop antenna, whereby an IC chip inside the non-contact ID card performs the sending and receiving of data based on a wireless communication. For example, the non-contact ID card 1005, RFID (Radio Frequency Identification), a μ-chip, etc. The non-contact ID card 1005 includes a memory for storing user ID information and utilizes an induced electric power from the outside to perform a wireless communication. While the present embodiment makes reference to a card, any device that would be able to provide the same functionality and would enable practice of the present invention is applicable.

An operation example of the non-contact ID card 1005 will now described. A data sending and receiving unit 303 receives an electric wave, via an antenna unit 302, including a terminal code transmitted from the card reader unit 202 of the MFP 100. In response to receipt of the electric wave, the control unit 301 sends the ID information corresponding to the terminal code stored in the memory unit 305 from the data sending and receiving unit 303 to the MFP 100. At this time, the control unit 301 writes the terminal code and the ID information in the memory unit 305 as register information. Herein, the ID information refers to, for example, a login name and a password with which the MFP 100 can be shifted to a usable status (e.g., a user is logged in). Also, the terminal code refers to a code including a device name of the MFP 100. The MFP 100, upon receipt of the ID information, performs an automatic login to display a list of the mobile information terminals capable of performing wireless communication on the display unit 203.

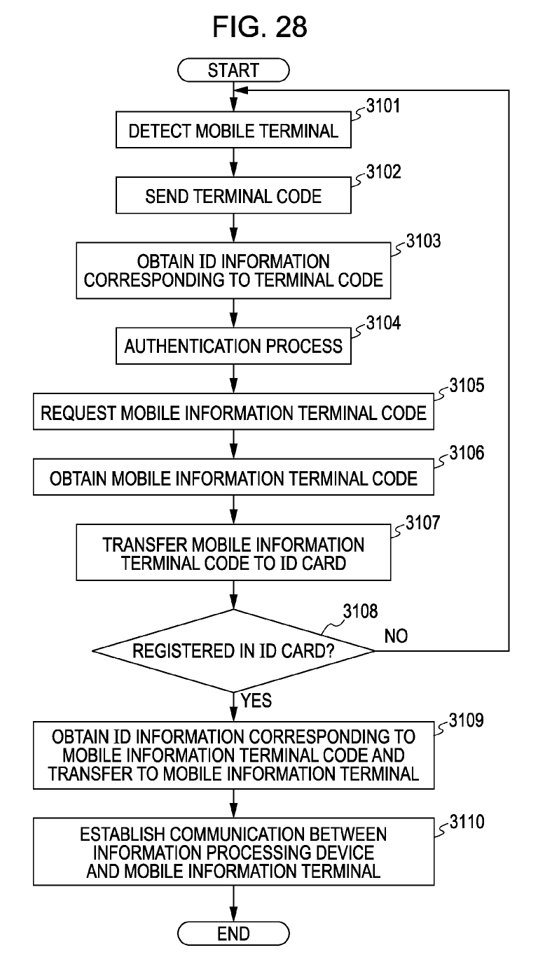

FIG. 28 illustrates the terminal detecting flow 3000 as performed according to the present invention. First, in step 3101, the mobile terminal detection unit 205 detects any mobile information terminals that are in vicinity of the MFP 100. In the present embodiment, detection occurs, when a user places the non-contact ID card 1005 close to the device sensor 1003. In step 3102, an electric wave including the terminal code of the MFP 100 is emitted from the card reader unit 202.

The distance the electric wave can travel is typically influenced by the communication environment, such as an antenna characteristic. A typical communication distance is for example, about 10 cm. When the non-contact ID card 1005 is placed close to the device sensor 1003, the non-contact ID card 1005, activated by receiving the electric wave, obtains the terminal code of the MFP 100 included in the electric wave. After that, the non-contact ID card 1005 sends the ID information corresponding to the received terminal code to the MFP 100. As a result, in step 3103, the MFP 100 obtains the ID information corresponding to the received terminal code from the non-contact ID card 1005. Then, in step 3104, the MFP 100 transfers the ID information corresponding to the received terminal code to the controller unit 201 for performing an authentication process. After establishing the authentication, the controller unit 201 shifts the MFP 100 into the usable status, i.e., the user is logged into the MFP 100.

Next, in step 3105, the MFP 100 requests the mobile information terminal for a mobile information terminal code in order to search for the mobile information terminal that can perform the wireless communication within a wireless communication range. As a result, the mobile information terminal responds to the mobile information terminal code request by sending the mobile information terminal code, and the MFP 100 in step 3106 obtains the mobile information terminal code. In order for the controller unit 201 to check whether the obtained mobile information terminal code is registered in the memory unit 305 in the non-contact ID card 1005, in step 3107, the received mobile information terminal code is transferred from the card reader unit 202 to the non-contact ID card 1005. Herein, the mobile information terminal code refers to a code including information such as a device name of the mobile information terminal.

In step 3108, the non-contact ID card 1005 determines whether the received mobile information terminal code is registered in the memory unit 305. If the received mobile information terminal code is registered, the non-contact ID card 1005 sends the ID information corresponding to the mobile information terminal code to the MFP 100. As a result, the MFP 100 obtains the ID information corresponding to the mobile information terminal code. The MFP 100 confirms the mobile information terminal identified by the ID information corresponding to the received mobile information terminal code as the wireless communication party. After that, in step 3109, login is performed with respect to the mobile information terminal, and the ID information corresponding to the mobile information terminal code is transferred from the wireless communication unit 206 of the MFP 100 to the mobile information terminal. Then, in step 3110, a communication between the MFP 100 and the mobile information terminal is established, whereby the sending and receiving of the mail information and the image data can be conducted.

According to the present embodiment, if the mobile information terminal code received by the non-contact ID card 1005 is not registered in the memory unit 305, the detection of the mobile information terminal is performed again. In addition, according to the present embodiment, when the user logs into the MFP 100, information of the mobile information terminal used by the user is registered in the non-contact ID card 1005. As a result, the MFP 100 can easily identify the mobile information terminal with which the wireless communication is performed. Furthermore, the login operation to the MFP 100 and the mobile information terminal can be performed at the same time without conducting the key operation by the user.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-115719 filed Apr. 19, 2006, and No. 2006-329623 filed Dec. 6, 2006, which is hereby incorporated by reference herein in its entirety.

What is claimed is:

1. An information processing device capable of communicating with a plurality of mobile information terminals that include an electronic mail composition function and a sending function, comprising:
a terminal detection unit configured to detect at least one mobile information terminal;
an obtaining unit configured to obtain mail information from the at least one mobile information terminal in accordance with the detection of the at least one mobile information terminal; and
a sending unit configured to send an electronic mail based on the mail information.

2. The information processing device according to claim 1, further comprising a status detection unit configured to detect a status of the mail information stored in the at least one mobile information terminal.

3. The information processing device according to claim 2, wherein the detection unit detects mail information with an unsent status.

4. The information processing device according to claim 3, wherein the obtaining unit obtains mail information with an unsent status.

5. The information processing device according to claim 1, wherein the mail information obtained by the obtaining unit includes destination mail address information, and wherein the information processing device further comprises a determination unit configured to determine a device type that becomes a destination of the electronic mail designated by the destination mail address information and a transfer unit configured to transfer the mail information to the at least one mobile information terminal detected by the terminal detection unit when the determination unit determines that the device type designated by the destination mail address information is the at least one mobile information terminal.

6. The information processing device according to claim 5, wherein when the determination unit determines that the device type designated by the destination mail address information is the at least one mobile information terminal, the transfer unit converts the mail information into a status in which the mail information can be used by the at least one mobile information terminal.

7. The information processing device according to claim 1, further comprising an image reading unit configured to read an original containing an image, wherein at a time of sending an electronic mail by the sending unit, if the image reading unit detects the existence of an original, the reading unit commences reading of the original and image information obtained by the reading is added to the mail information.

8. The information processing device according to claim 1, wherein when the terminal detection unit no longer detects the at least one mobile information terminal, the sending unit sends the electronic mail.

9. The information processing device according to claim 1, wherein the information processing device is able to communicate with a plurality of mobile information terminals and further comprises an ID obtaining unit configured to obtain a device ID for identifying the mobile information terminal that communicates with the information processing device from a first mobile information terminal, and the information processing device communicates with a second mobile information terminal corresponding to the device ID obtained by the ID obtaining unit.

10. A method executed by an information processing device capable of communicating with a plurality of mobile information terminals that include an electronic mail composition function and a sending function, the method comprising:
detecting at least one mobile information terminal;
obtaining mail information from the at least one mobile information terminal in accordance with the detection of the at least one mobile information terminal; and
sending an electronic mail based on the mail information.

11. The method according to claim 10, further comprising obtaining a device ID for identifying the at least one mobile information terminal that has been detected.

12. The method according to claim 10, further comprising detecting a status of the mail information stored in the at least one mobile information terminal.

13. The method according to claim 12, wherein the detection unit detects mail information with an unsent status.

14. The method according to claim 13, wherein mail information with an unsent status is obtained.

15. The method according to claim 10, wherein obtained mail information includes destination mail address information, and wherein the method further comprises determining a device type that becomes a destination of the electronic mail designated by the destination mail address information and transferring the mail information to a detected at least one mobile information terminal when it is determined that the device type designated by the destination mail address information is the at least one mobile information terminal.

16. The method according to claim 15, wherein when it is determined that the device type designated by the destination mail address information is the at least one mobile information terminal, the mail information is converted into a status in which the mail information can be used by the at least one mobile information terminal.

17. The method according to claim 10, further comprising reading an original containing an image, wherein at a time of sending an electronic mail, if the image processing device detects the existence of an original nit, reading of the original commences, and image information obtained by the reading is added to the mail information.

18. The method according to claim 10, wherein when the mobile information terminal is no longer detected, the electronic mail is sent.

19. A computer-readable storage medium storing computer-executable process steps, the computer-executable process steps causing a computer to execute the method of claim 10.

20. An information processing device capable of communicating with a plurality of mobile information terminals that include an electronic mail function of composing and sending an electronic mail, comprising:
a terminal detection unit configured to detect at least one mobile information terminal; and
a display control unit configured to display a display screen based on the electronic mail function in accordance with the detection of the at least one mobile information terminal.

21. An information processing device capable of communicating with a plurality of mobile information terminals that include an electronic mail function of composing and sending an electronic mail, comprising:
a terminal detection unit configured to detect at least one mobile information terminal;
an activation unit configured to activate the electronic mail function for processing mail information obtained by the at least one mobile information terminal in accordance with detection of the at least one mobile information terminal; and
a sending unit configured to send the electronic mail based on the mail information obtained by the at least one mobile information terminal using the electronic mail function activated by the activation unit.

22. The information processing device according to claim 21, wherein the mail information stored at the at least one mobile information terminal includes mail information in an unsent status that is not sent as an electronic mail from the at least one mobile information terminal, and wherein the activation unit activates the electronic mail function when there is mail information in an unsent status in the mail information stored at the at least one mobile information terminal.

23. A method executed by an information processing device capable of communicating with a plurality of mobile information terminals that include an electronic mail function of composing and sending an electronic mail, the method comprising:
detecting at least one mobile information terminal;
displaying a display screen based on the electronic mail function in accordance with detection of the at least one mobile information terminal.

24. A computer-readable storage medium storing computer-executable process steps for causing a computer to execute the method of claim 23.

25. A method executed by an information processing device capable of communicating with a plurality of mobile information terminals that include an electronic mail function of composing and sending an electronic mail, the method comprising:
detecting at least one mobile information terminal;
activating the electronic mail function for processing the mail information obtained by the at least one mobile information terminal in accordance with detection of the at least one mobile information terminal; and
sending the electronic mail based on the mail information obtained by the at least one mobile information terminal using the activated electronic mail function.

26. A computer-readable storage medium storing computer-executable process steps, the computer-executable process steps causing a computer to execute the method of claim 25.
